(19) United States
(12) Patent Application Publication
(10) Pub. No.: US 2017/0154178 A1
(43) Pub. Date: Jun. 1, 2017

(54) PORTABLE TERMINAL AND METHOD OF CONTROLLING LOCKING OF PORTABLE TERMINAL

(71) Applicant: KYOCERA CORPORATION, Kyoto (JP)

(72) Inventor: Masamitsu HAMASAKI, Yokohama-shi (JP)

(21) Appl. No.: 15/430,225

(22) Filed: Feb. 10, 2017

Related U.S. Application Data
(63) Continuation of application No. PCT/JP2015/072832, filed on Aug. 12, 2015.

(30) Foreign Application Priority Data
Aug. 14, 2014 (JP) 2014-165132

(51) Int. Cl. G06F 21/35; H04M 1/667; H04W 12/08; G06F 3/0346

(52) U.S. Cl. CPC G06F 21/35; G06F 3/0346; H04M 1/667; H04W 12/08

(57) ABSTRACT

A wearable terminal is configured to transmit to a portable terminal, authentication information and first acceleration data output from an acceleration sensor. An acceleration sensor of the portable terminal is configured to output the second acceleration data. At least one processor is configured to control cancellation of a locking function based on whether or not the first acceleration data and second acceleration data indicate that the wearable terminal and the portable terminal are held by the same user when the authentication information transmitted from the wearable terminal is successfully authenticated while the locking function has been set.

### CROSS-REFERENCE TO RELATED APPLICATION

The present application is a continuation based on PCT Application No. PCT/JP2015/072832 filed on Aug. 12, 2015, which claims the benefit of Japanese Application No. 2014-165132 filed on Aug. 14, 2014. PCT Application No. PCT/JP2015/072832 is entitled “Portable Device and Lock Control Method for Portable Device,” and Japanese Application No. 2014-165132 is entitled “Portable Terminal and Method of Controlling Locking of Portable Terminal.” The content of which is incorporated by reference herein in their entirety.

### FIELD

The present disclosure relates to a portable terminal and a method of controlling locking of a portable terminal.

### BACKGROUND

For example, a portable terminal representing one example of the background art establishes near field communication with an authentication information recording medium attached to a watch possessed by a user when a condition for performing specific processing specified in correspondence with an input from a user is satisfied in a locked state in which execution of the specific processing is prohibited. The portable terminal obtains ID information recorded in the authentication information recording medium and is unlocked when the ID information is successfully authenticated.

### SUMMARY

A portable terminal includes a communicator configured to communicate with a wearable terminal including a first acceleration sensor which outputs first acceleration data, at least one processor configured to set and cancel a locking function, and a second acceleration sensor configured to output second acceleration data. The communicator is configured to receive the first acceleration data. The at least one processor is configured to control cancellation of the locking function based on whether or not the first acceleration data and the second acceleration data indicate that the wearable terminal and the portable terminal are held by the same user while the locking function has been set,

### BRIEF DESCRIPTION OF THE DRAWINGS

FIG. 1 is a diagram showing an electronic system including a portable terminal and a wearable terminal in an embodiment.

FIG. 2A is a diagram showing a state before an operation of an arm of a user.

FIG. 2B is a diagram showing a state after the operation of the arm of the user.

FIG. 3 is a flowchart showing a procedure for setting and canceling a locking function in a first embodiment.

FIG. 4 is a diagram for illustrating an effect in the first embodiment.

FIG. 5A is a diagram showing a state before an operation of an arm of a user.

FIG. 5B is a diagram showing a state after the operation of the arm of the user.

FIG. 6 is a flowchart showing a procedure for setting and canceling the locking function in a second embodiment.

FIG. 7 is a diagram showing an example of cancellation of the locking function in a third embodiment.

FIG. 8 is a flowchart showing a procedure for setting and canceling the locking function in the third embodiment.

FIG. 9 is a flowchart showing a procedure for setting and canceling the locking function in a fourth embodiment.

### DETAILED DESCRIPTION

An embodiment will be described below with reference to the drawings.

In an unlocking method in one example of the background art, for example, if only a user who wears a watch to which an authentication information recording medium is attached is present around a portable terminal in spite of the fact that the user is not holding a portable terminal, the portable terminal is unlocked. Consequently, a third party can operate the unlocked portable terminal without permission, which poses a security problem. Such a problem can be solved by the disclosure below.

### First Embodiment

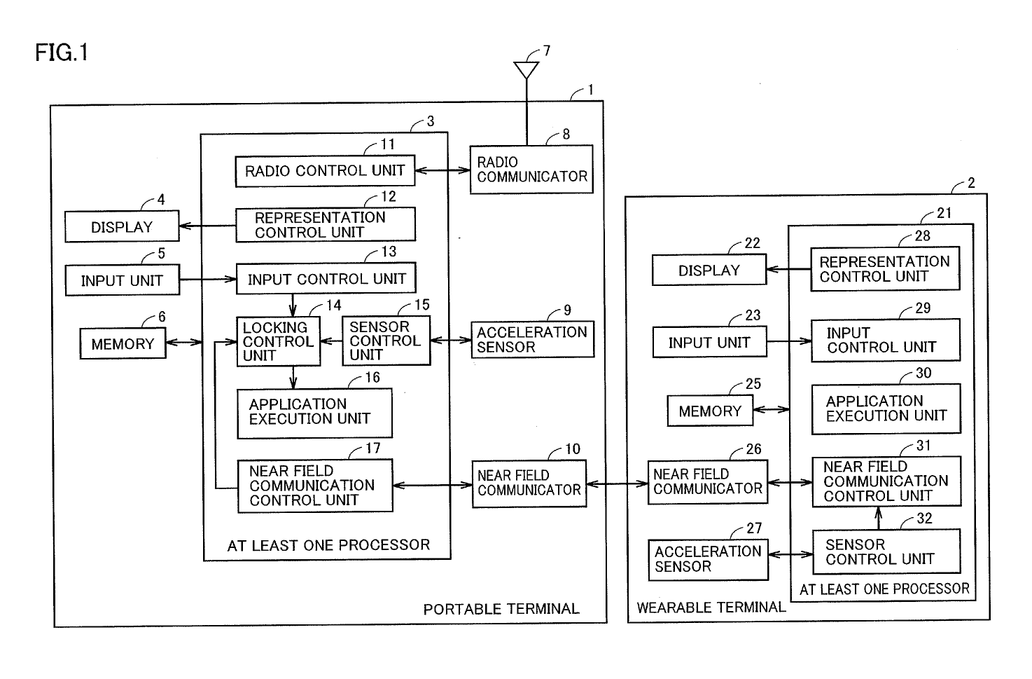

FIG. 1 is a diagram showing an electronic system including a portable terminal 1 and a wearable terminal 2 in an embodiment.

Wearable terminal 2 is attached to an arm of a user. Wearable terminal 2 includes at least one processor 21, a display 22, an input unit 23, a memory 25, a near field communicator 26, and an acceleration sensor 27. At least one processor 21 functions as a representation control unit 28, an input control unit 29, an application execution unit 30, a near field communication control unit 31, and a sensor control unit 32.

In accordance with various embodiments, at least one processor 21 may be implemented as a single integrated circuit (IC) or as multiple communicatively coupled IC's and/or discrete circuits. At least one processor 21 can be implemented in accordance with various known technologies.

In one embodiment, at least one processor 21 includes one or more circuits or units configurable to perform one or more data computing procedures or processes. For example, at least one processor 21 may include one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described below.

Application execution unit 30 can execute an application for wearable terminal 2.

Display 22 can show a result of execution by application execution unit 30. Representation control unit 28 can control representation on display 22.

Input unit 23 can accept an input from a user. Input control unit 29 can control input unit 23.

In various embodiments, input unit 23 may be implemented using any input technology or device known in the art such as, for example, a QWERTY keyboard, a pointing device (e.g., a mouse), a joy stick, a stylus, a touch screen display panel, a key pad, one or more buttons, etc., or any combination of these technologies.

Acceleration sensor 27 can output first acceleration data. Sensor control unit 32 can control an operation of acceleration sensor 27.

Memory 25 can store a first authentication ID.

Near field communicator 26 can communicate with portable terminal 1. Specifically, near field communicator 26 can transmit a first authentication ID stored in memory 25 to portable terminal 1 upon reception of an instruction from portable terminal 1. Near field communicator 26 can transmit the first acceleration data output from acceleration sensor 27 to portable terminal 1 upon reception of an instruction from portable terminal 1. Near field communication control unit 31 can control an operation of near field communicator 26.

Portable terminal 1 includes a display 4, an input unit 5, a memory 6, an antenna 7, a radio communicator 8, an acceleration sensor 9, a near field communicator 10, and at least one processor 3. At least one processor 3 functions as a radio control unit 11, a representation control unit 12, an input control unit 13, a locking control unit 14, a sensor control unit 15, an application execution unit 16, and a near field communication control unit 17.

In accordance with various embodiments, at least one processor 3 may be implemented as a single integrated circuit (IC) or as multiple communicatively coupled IC's and/or discrete circuits. At least one processor 3 can be implemented in accordance with various known technologies.

In one embodiment, at least one processor 3 includes one or more circuits or units configurable to perform one or more data computing procedures or processes. For example, at least one processor 3 may include one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described below.

Application execution unit 16 can execute various applications.

Display 4 can show a result of execution by application execution unit 16. Representation control unit 12 can control representation on display 4,

Input unit 5 can accept an input from a user. Input control unit 13 can control input unit 5.

In various embodiments, input unit 23 may be implemented using any input technology or device known in the art such as, for example, a QWERTY keyboard, a pointing device (e.g., a mouse), a joy stick, a stylus, a touch screen display panel, a key pad, one or more buttons, etc., or any combination of these technologies,

Input unit 5 can detect contact or proximity of an object (a finger of a user or a pen), for example, in accordance with a capacitance.

Radio communicator 8 can establish radio communication with a not-shown radio base station through antenna 7.

Acceleration sensor 9 can output second acceleration data. Sensor control unit 15 can control an operation of acceleration sensor 9.

Memory 6 can store a second authentication ID.

Near field communicator 10 can communicate with wearable terminal 2. Specifically, near field communicator 10 can instruct wearable terminal 2 to transmit a first authentication ID while a locking function has been set, and can receive the first authentication ID transmitted from wearable terminal 2 in response to the instruction. Near field communicator 10 can instruct wearable terminal 2 to transmit first acceleration data while the locking function has been set and can receive the first acceleration data transmitted from wearable terminal 2 in response to the instruction.

Locking control unit 14 can set and cancel the locking function. Locking control unit 14 can set the locking function after power is turned on and portable terminal 1 is launched. Locking control unit 14 can accept no input from a user except for entry of a password while the locking function has been set. In a locked state, however, an operation for an emergency call (to telephone numbers 110, 119, and 116 in Japan and 911 in the United States) can be performed in order to permit placement of an emergency telephone call. A limited function may be activated without unlocking. For example, only a camera function may be activated with a prescribed operation. Without being limited to a camera, on/off of an airplane mode may be controlled.

Locking control unit 14 can compare a second authentication ID stored in memory 6 with a first authentication ID sent from wearable terminal 2. Locking control unit 14 can determine that the received first authentication ID is successfully authenticated when a result of comparison indicates match.

Locking control unit 14 can cancel the locking function when the received first authentication ID is successfully authenticated and when the received first acceleration data output from acceleration sensor 27 and second acceleration data output from acceleration sensor 9 satisfy a prescribed condition while the locking function has been set. The prescribed condition can be such a condition that first acceleration data and second acceleration data indicate that wearable terminal 2 and portable terminal 1 are held by the same user.

In the first embodiment, locking control unit 14 can cancel the locking function when the first acceleration data and the second acceleration data indicate that portable terminal 1 is held in a palm of an arm to which wearable terminal 2 is attached. For example, when a direction of an acceleration indicated by the first acceleration data and a direction of an acceleration indicated by the second acceleration data are substantially the same (also including the same), that is, when a difference in direction of acceleration is within a prescribed angle, a user can be regarded as holding portable terminal 1 in the palm of the arm to which wearable terminal 2 is attached.

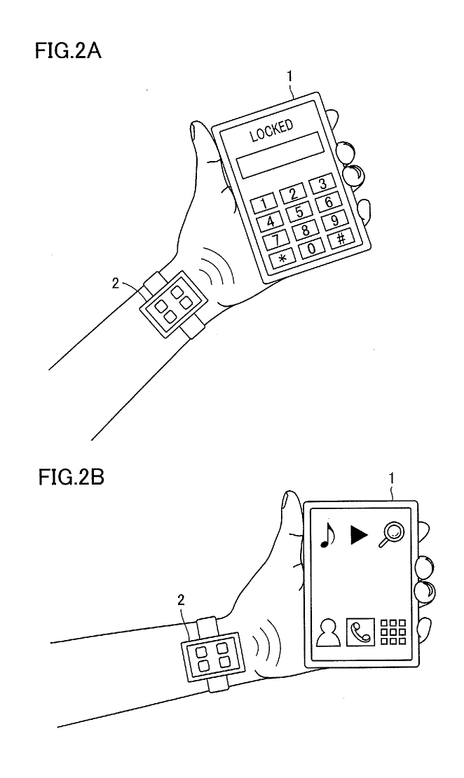

FIGS. 2A and 2B are diagrams showing an example of cancellation of the locking function in the first embodiment.

FIG. 2A shows a state before an operation of an arm of a user and FIG. 2B shows a state after the operation of the arm of the user.

When a user wears wearable terminal 2 on a left arm and moves the left arm while he/she holds portable terminal 1 in his/her left palm, a direction of an acceleration indicated by the first acceleration data and a direction of an acceleration indicated by the second acceleration data are substantially the same (also including the same) and the locking function can be canceled.

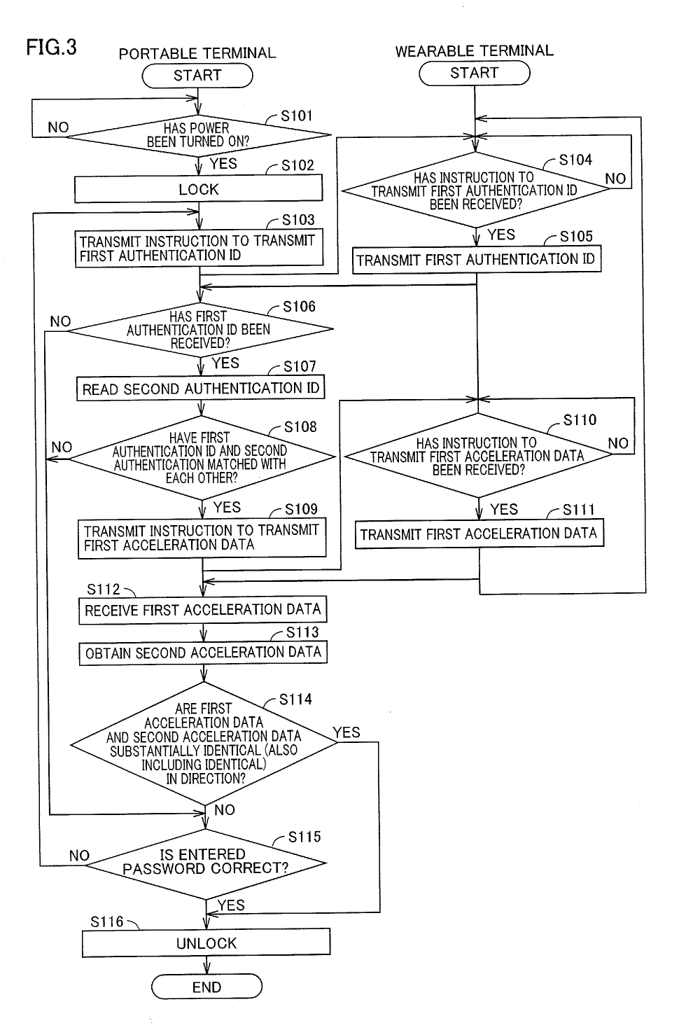

FIG. 3 is a flowchart showing a procedure for setting and canceling the locking function in the first embodiment.

Initially, when a user presses a not-shown power-on button of portable terminal 1 in step S101, the process proceeds to step S102.

In step S102, locking control unit 14 of portable terminal 1 can have display 4 show a locking screen by means of representation control unit 28 and can set the locking function.

In step S103, locking control unit 14 of portable terminal 1 can instruct wearable terminal 2 to transmit a first authentication ID through near field communicator 10.

When near field communicator 26 of wearable terminal 2 receives the instruction to transmit the first authentication ID in step S104, the process proceeds to step S105.

In step S105, near field communicator 26 of wearable terminal 2 can transmit the first authentication ID stored in memory 25.

When locking control unit 14 of portable terminal 1 receives the first authentication ID from wearable terminal 2 through near field communicator 10 in step S106, the process proceeds to step S107. When locking control unit 14 does not receive the first authentication ID, the process proceeds to step S115.

In step S107, locking control unit 14 of portable terminal 1 can read a second authentication ID stored in memory 6.

In step S108, locking control unit 14 of portable terminal 1 can compare the received first authentication ID and the read second authentication ID with each other. When a result of comparison indicates match, the process proceeds to step S109, and otherwise, the process proceeds to step S115.

In step S109, locking control unit 14 of portable terminal 1 can instruct wearable terminal 2 to transmit first acceleration data output from acceleration sensor 27 of wearable terminal 2 through near field communicator 10.

When near field communicator 26 of wearable terminal 2 receives the instruction to transmit the first acceleration data in step 5110, the process proceeds to step S111.

In step S111, near field communicator 26 of wearable terminal 2 can transmit the first acceleration data output from acceleration sensor 27 to portable terminal 1.

In step S112, locking control unit 14 of portable terminal 1 can receive the first acceleration data from wearable terminal 2 through near field communicator 10.

In step S113, locking control unit 14 of portable terminal 1 can obtain second acceleration data output from acceleration sensor 9 of portable terminal 1.

When a direction of an acceleration indicated by the first acceleration data and a direction of an acceleration indicated by the second acceleration data are substantially the same (also including the same) in step S114, that is, a difference in direction of an acceleration is within a prescribed angle, locking control unit 14 of portable terminal 1 can determine that a user holds portable terminal 1 in his/her palm of an arm to which wearable terminal 2 is attached. Therefore, the process proceeds to step S116. When that condition is not satisfied, the process proceeds to step S115.

In step S115, locking control unit 14 can determine whether or not a password entered by the user through input unit 5 is correct. When the password is correct, the process proceeds to step S116, and otherwise, the process returns to step S103.

In step S116, locking control unit 14 can cancel the locking function.

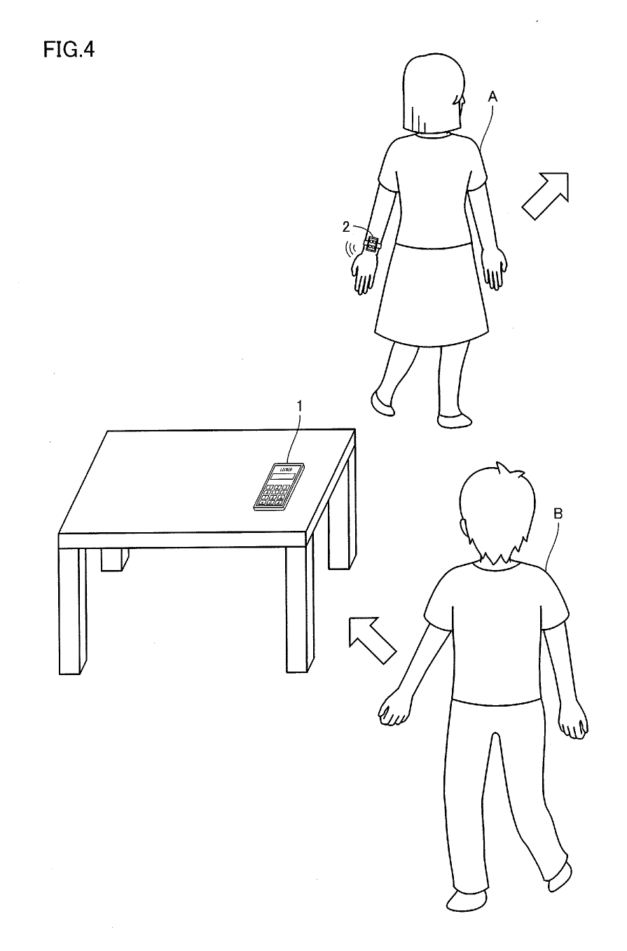

FIG. 4 is a diagram for illustrating an effect in the first embodiment.

When a person A who wears wearable terminal 2 moves with portable terminal 1 being left on a desk and when a first authentication ID transmitted from wearable terminal 2 is received by portable terminal 1, the locking function is canceled in a conventional example. Consequently, another person B can operate portable terminal 1.

In the first embodiment, portable terminal 1 is stationary. Therefore, a direction of an acceleration indicated by the second acceleration data output from acceleration sensor 9 of portable terminal 1 and a direction of an acceleration indicated by the first acceleration data output from acceleration sensor 27 of wearable terminal 2 are not substantially the same (also including the same). Therefore, since the locking function is not canceled, operation of portable terminal 1 by another person B can be prevented.

As set forth above, according to the first embodiment, the locking function is canceled when a user holds a wearable terminal and a portable terminal with the same hand and moves that hand. Therefore, cancellation of the locking function of the portable terminal while a user who wears the wearable terminal is not holding the portable terminal can be prevented.

Even when a direction of an acceleration indicated by the first acceleration data and a direction of an acceleration indicated by the second acceleration data are not substantially the same (also including the same), a screen for entering a password is shown and the portable terminal is unlocked when a password entered by a user through input unit 5 is correct. Therefore, even though a user forgets a method of unlocking by holding a wearable terminal and a portable terminal and performing an operation, the portable terminal can be unlocked.

A screen for entering a password does not have to be shown when determination as NO is made in step S114, but the process may return to step S103.

### Second Embodiment

In a second embodiment, locking control unit 14 can cancel the locking function when first acceleration data and second acceleration data indicate that portable terminal 1 is held in a palm of a second arm different from a first arm to which wearable terminal 2 is attached and the first arm and the second arm operate in a prescribed pattern. The prescribed pattern can be, for example, such a pattern that the first arm and the second arm move in opposite directions. In this case, a direction of an acceleration indicated by the first acceleration data and a direction of an acceleration indicated by the second acceleration data are substantially opposite (also including opposite), that is, a difference between a direction resulting from rotation around 180° from a direction of an acceleration indicated by the first acceleration data and a direction of an acceleration indicated by the second acceleration data is within a prescribed angle.

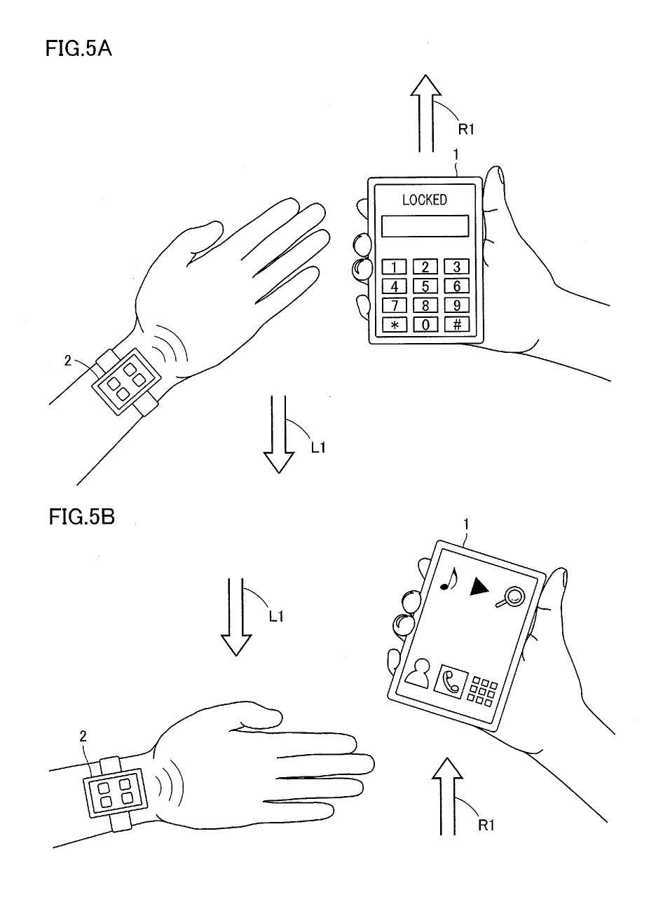

FIGS. 5A and 5B are diagrams showing an example of cancellation of the locking function in the second embodiment.

FIG. 5A shows a state before an operation of an arm of a user and FIG. 5B shows a state after the operation of the arm of the user.

As shown in FIG. 5A, with a user wearing wearable terminal 2 on a first arm (left arm) and holding portable terminal 1 in a palm of a second arm (right arm), when the first arm moves vertically downward (a direction shown with an arrow L1 in FIG. 5A) and the second arm moves vertically upward (a direction shown with an arrow RI in FIG. 5A), a state of the arms of the user changes as shown in FIG. 5B.

At this time, a direction of an acceleration indicated by the first acceleration data and a direction of an acceleration indicated by the second acceleration data are substantially opposite (also including opposite) and the locking function can be canceled.

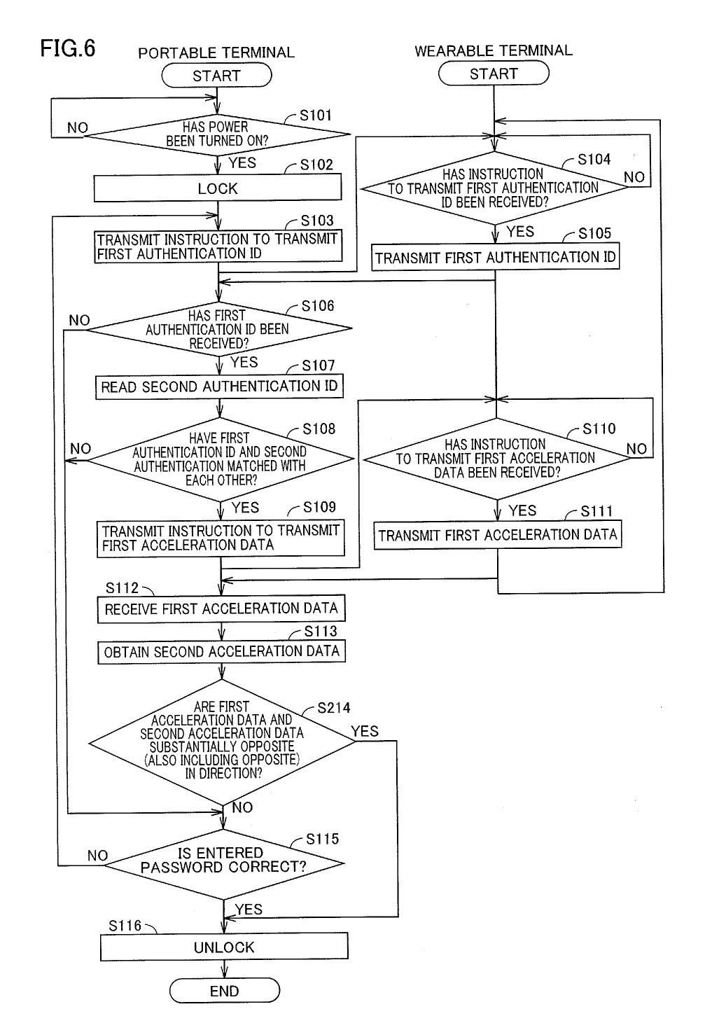

FIG. 6 is a flowchart showing a procedure for setting and canceling the locking function in the second embodiment.

The flowchart in FIG. 6 is different from the flowchart in FIG. 3 in including step S214 instead of step S114.

Referring to FIG. 6, when a direction of an acceleration indicated by the first acceleration data and a direction of an acceleration indicated by the second acceleration data are substantially opposite (also including opposite) in step S214, locking control unit 14 of portable terminal 1 can determine that portable terminal 1 is held in the palm of the second arm different from the first arm to which wearable terminal 2 is attached and the first arm and the second arm move in opposite directions. Therefore, the process proceeds to step S116. When that condition is not satisfied, the process proceeds to step S115.

As set forth above, according to the second embodiment, the locking function is canceled when the user holds the wearable terminal and the portable terminal with different hands and moves those hands in a prescribed pattern. Therefore, cancellation of the locking function of the portable terminal when the user who wears the wearable terminal is not holding the portable terminal can be prevented.

The prescribed pattern may be drawing of a predetermined character, sign, or graphics with the first and second arms.

### Third Embodiment

In a third embodiment, locking control unit 14 can cancel the locking function when first acceleration data and second acceleration data indicate that a user who wears wearable terminal 2 and holds portable terminal 1 moves.

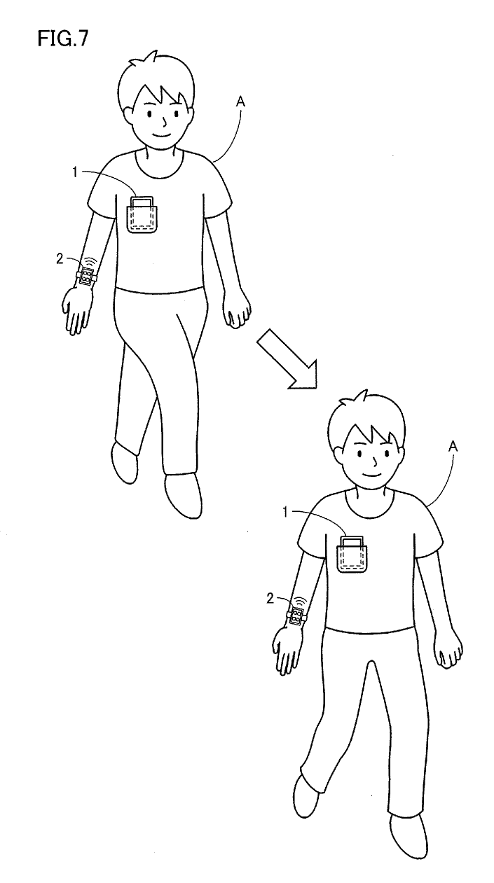

FIG. 7 is a diagram showing an example of cancellation of the locking function in the third embodiment.

When a user A moves while he/she wears wearable terminal 2 and holds portable terminal 1, movement indicated by the first acceleration data and movement indicated by the second acceleration data are the same in characteristics. Therefore, whether or not the user who wears wearable terminal 2 and holds portable terminal 1 moves can be determined based on the first acceleration data and the second acceleration data.

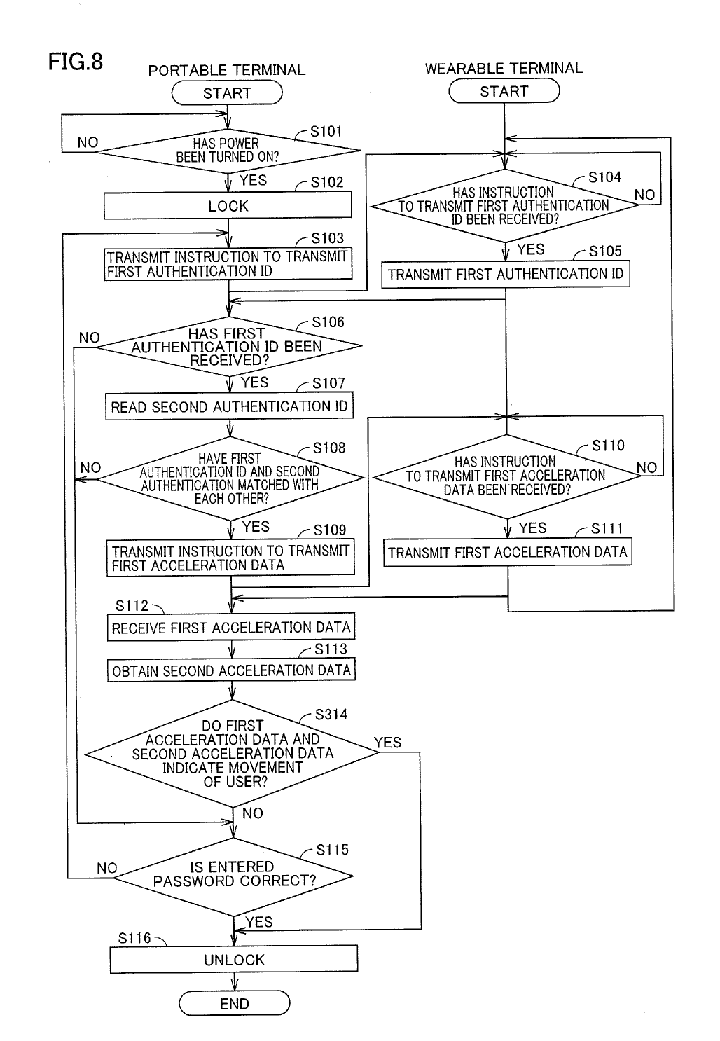

FIG. 8 is a flowchart showing a procedure for setting and canceling the locking function in the third embodiment.

The flowchart in FIG. 8 is different from the flowchart in FIG. 3 in including step S314 instead of step S114.

Referring to FIG. 8, when locking control unit 14 of portable terminal 1 can determine in step S314 based on the first acceleration data and the second acceleration data that the user who wears wearable terminal 2 and holds portable terminal 1 moves, the process proceeds to step S116. When that condition is not satisfied, the process proceeds to step S115.

As set forth above, according to the third embodiment, since the locking function is canceled when the user moves while he/she holds the wearable terminal and the portable terminal, cancellation of the locking function of the portable terminal while the user who wears the wearable terminal is not holding the portable terminal can be prevented.

### Fourth Embodiment

In a fourth embodiment, locking control unit 14 can simplify cancellation of the locking function instead of cancellation of the locking function when first acceleration data and second acceleration data indicate that portable terminal 1 is held in a palm of an arm to which wearable terminal 2 is attached. By way of example of simplification, locking control unit 14 can cancel the locking function based on entry of a simplified password when entry of a password is required for cancellation of the locking function and when the above-described condition is satisfied. For example, when a password includes eight characters, a simplified password can include four characters from the top of the eight characters of the password.

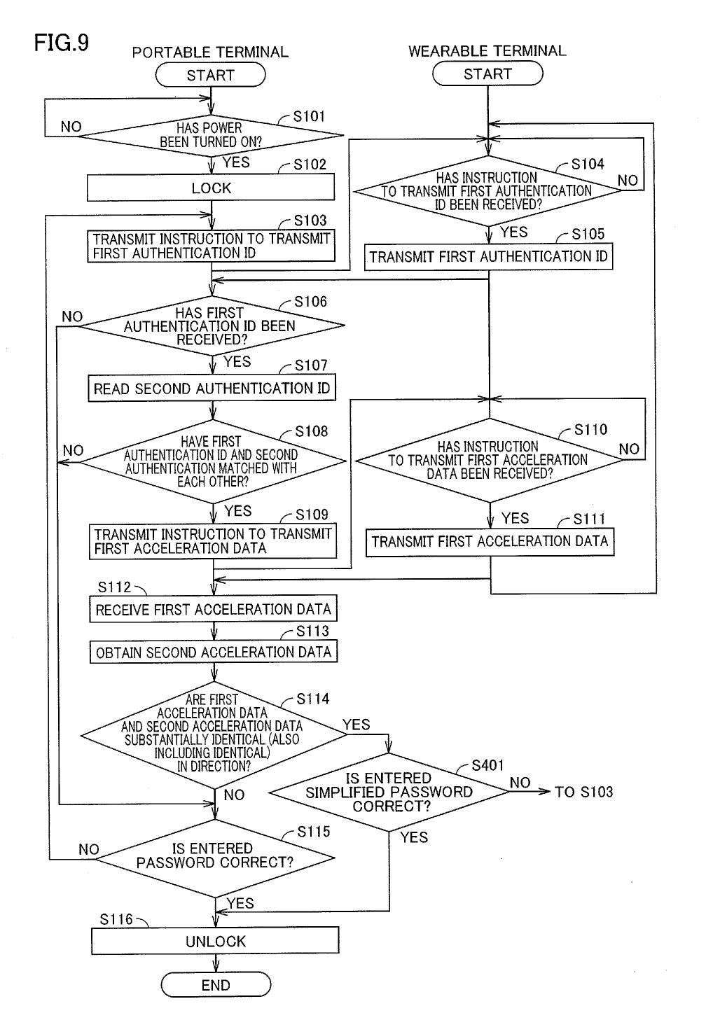

FIG. 9 is a flowchart showing a procedure for setting and canceling the locking function in the fourth embodiment.

The flowchart in FIG. 9 is different from the flowchart in FIG. 3 in that the process proceeds to step S401 when determination as NO is made in step S114.

Referring to FIG. 9, in step S401, locking control unit 14 can determine whether or not a simplified password entered by a user through input unit 5 is correct. When the simplified password is correct, the process proceeds to step S116, and otherwise, the process returns to step S103.

As set forth above, in the fourth embodiment, cancellation of the locking function is simplified when the user holds the wearable terminal and the portable terminal with the same hand and moves that hand. Therefore, cancellation of the locking function of the portable terminal while the user who wears the wearable terminal is not holding the portable terminal can be prevented.

Though simplification of cancellation of the locking function instead of cancellation of the locking function in the first embodiment has been described in the fourth embodiment, limitation thereto is not intended.

Cancellation of the locking function may be simplified instead of cancellation of the locking function in the second and third embodiments.

The process may proceed to step S401 when determination as YES in made in step S214 in the flowchart in FIG. 6. The process may proceed to step S401 when determination as YES is made in step S314 in the flowchart in FIG. 8.

Though a watch type wearable terminal attached to a user's arm has been described as a wearable terminal in embodiments, limitation thereto is not intended. A wearable terminal may be a ring type wearable terminal or a head mounted display.

Though successful authorization of a wearable terminal is the precondition for cancellation or simplification of cancellation of the locking function in embodiments described above, limitation thereto is not intended. A procedure for authentication of a wearable terminal does not have to be performed.

For example, the processing in steps S103 to S108 in FIGS. 3, 6, 8, and 9 in the first to fourth embodiments does not have to be performed.

When an acceleration indicated by the first acceleration data and an acceleration indicated by the second acceleration data are both “0” in FIGS. 3, 6, and 9, determination in steps S114, S214, and S314 does not have to be made or unlocking does not have to be performed.

Though embodiments have been described, it should be understood that embodiments disclosed herein are illustrative and non-restrictive in every respect. The scope of the present disclosure is defined by the terms of the claims and is intended to include any modifications within the scope and meaning equivalent to the terms of the claims.

1. A portable terminal comprising:
a communicator configured to communicate with a wearable terminal including a first acceleration sensor which outputs first acceleration data;
at least one processor configured to set and cancel a locking function of the portable terminal; and
a second acceleration sensor configured to output second acceleration data,
the communicator being configured to receive the first acceleration data, and
the at least one processor being configured to control cancellation of the locking function based on whether the first acceleration data and the second acceleration data indicate that the wearable terminal and the portable terminal are held by same user while the locking function has been set.

2. The portable terminal according to claim 1, wherein
the wearable terminal is further configured to transmit authentication information to the portable terminal,
the communicator is further configured to receive the authentication information from the wearable terminal, and
the at least one processor is configured to control cancellation of the locking function based on whether the first acceleration data and the second acceleration data indicate that the wearable terminal and the portable terminal are held by the same user only when the received authentication information is successfully authenticated while the locking function has been set.

3. The portable terminal according to claim 1, wherein
the at least one processor is configured to cancel the locking function when the first acceleration data and the second acceleration data indicate that the wearable terminal and the portable terminal are held by the same user.

4. The portable terminal according to claim 1, wherein
the at least one processor is configured to simplify cancellation of the locking function when the first acceleration data and the second acceleration data indicate that the wearable terminal and the portable terminal are held by the same user.

5. The portable terminal according to claim 4, the portable terminal comprising an input unit configured to accept an input from a user, wherein
the at least one processor is configured to request entry of a password through the input unit for cancellation of the locking function and to cancel the locking function when the first acceleration data and the second acceleration data indicate that the wearable terminal and the portable terminal are held by the same user and when some of a plurality of characters defining the password are entered.

6. The portable terminal according to claim 1, wherein
the at least one processor is configured to cancel the locking function or simplify cancellation of the locking function when the first acceleration data and the second acceleration data indicate that the portable terminal is held in a palm of an arm to which the wearable terminal is attached.

7. The portable terminal according to claim 1, wherein
the at least one processor is configured to cancel the locking function or simplify cancellation of the locking function when the first acceleration data and the second acceleration data indicate that the portable terminal is held in a palm of a second arm different from a first arm to which the wearable terminal is attached and that the first arm and the second arm operate in a prescribed pattern.

8. The portable terminal according to claim 1, wherein
the at least one processor is configured to cancel the locking function or simplify cancellation of the locking function when the first acceleration data and the second acceleration data indicate that a user who wears the wearable terminal and holds the portable terminal moves.

9. A method of controlling locking of a portable terminal which can communicate with a wearable terminal, the wearable terminal including a first acceleration sensor which outputs first acceleration data, the portable terminal including a second acceleration sensor which outputs second acceleration data, the method comprising:
setting a locking function by the portable terminal;
receiving, by the portable terminal, authentication information transmitted from the wearable terminal;
determining, by the portable terminal, whether the received authentication information is successfully authenticated;
receiving, by the portable terminal, the first acceleration data transmitted from the wearable terminal; and
controlling, by the portable terminal, cancellation of the locking function based on whether the received first acceleration data and the second acceleration data output from the second acceleration sensor indicate that the wearable terminal and the portable terminal are held by same user when the received authentication information is successfully authenticated.

10. A portable terminal capable of communicating with a wearable terminal including a first acceleration sensor, the wearable terminal being capable of transmitting to the portable terminal, first acceleration data output from the first acceleration sensor, the portable terminal comprising:
a communicator configured to communicate with the wearable terminal;
at least one processor configured to set and cancel a locking function; and
a second acceleration sensor configured to output second acceleration data,
the communicator being configured to receive from the wearable terminal, the first acceleration data output from the first acceleration sensor, and
the at least one processor being configured to control cancellation of the locking function when the first acceleration data and the second acceleration data satisfy a prescribed condition while the locking function has been set.
